(19) United States
(12) Patent Application Publication
(10) Pub. No.: US 2009/0273244 A1
(43) Pub. Date: Nov. 5, 2009

(54) Electric Reciprocating Motion Device

(76) Inventor: Ming Luo, Shenzhen City (CN)

Correspondence Address: DAVID AND RAYMOND PATENT FIRM, 108 N. YNEZ AVE., SUITE 128, MONTEREY PARK, CA, 91754, US

(21) Appl. No.: 12/514,796

(22) PCT Filed: Jan. 4, 2007
(86) PCT No.: PCT/CN2007/000008

§ 371 Date: May 13, 2009

(30) Foreign Application Priority Data
Nov. 16, 2006 (CN) 200610149032.3

(51) Int. Cl. H02K 33/00

(52) U.S. Cl. 310/38

(57) ABSTRACT

An electric reciprocating motion device includes a casing (7), a mounting bracket (4) disposed within the casing (7), a motor (1), and its power supply (9) mounted and fixed on the mounting bracket (4), and a motion head (6) connected with the rotary shaft (11) of the motor (1). The motor (1) is a reciprocating swing motor. The motor (1) drives the motion head (6) to swing reciprocatively over a certain angle range around the axis which is the rotary shaft thereof.

### BACKGROUND OF THE PRESENT INVENTION

1. Field of Invention

The present invention relates to an electrical device, and more particularly to an electric reciprocating motion device.

2. Description of Related Arts

The existing electrical devices, such as an electric toothbrush with a vertical type brush head, can be mainly cataloged into the two following types. The first one is that an eccentric wheel is coupled with an output shaft of a motor, wherein when the electric toothbrush is operated the entire toothbrush and its brush head are vibrating in a certain range of amplitude. However, the vibrating amplitude of this type of toothbrush is relatively smaller. Another type of toothbrush is applied an electromagnetic induction principle to generate an electromagnetic vibration, so as to provide the vertical reciprocating motion at the brush head. However, the structure of the second type of toothbrush is complicated, its volume is relatively larger, and the noise from the toothbrush and energy power consumption is higher.

### SUMMARY OF THE PRESENT INVENTION

A main object of the present invention is to overcome the above drawbacks of the current techniques. The present invention provides an electric reciprocating motion device, which is convenient for use, simple in structure, small in volume, and having low noise and energy consumption.

Accordingly, in order to accomplish the above object, the present invention provides an electric reciprocating motion device to overcome the above drawbacks.

The electric reciprocating motion device, which comprises a casing, a mounting bracket provided within the casing, a motor supported by the mounting bracket, a power source electrically extended from the motor, and a motion head connected to a rotary shaft of the motor.

The electric reciprocating motion device has the following advantages.

The motor is the reciprocating swing motor, wherein the motion head is driven by the reciprocating motor to reciprocatively oscillate in a predetermined angle range regarding to the rotary shaft. Accordingly, the motion heads with various formations or practical functions can be selected to detachably insert into or couple with the rotary shaft of the motor or the connection shaft thereof, the electric reciprocating motion device of the present invention can drive the motion head to provide a corresponding formation or practical function thereof.

Accordingly, in order to accomplish the above object, the present invention also can be practiced by the followings.

A motor function control circuit board is provided, wherein a control circuit of the control circuit board comprises a functional selection and speed controlling circuit, a square-wave oscillation and regulating circuit, and a motor driving circuit electrically connected in series manner.

The control circuit of the control circuit board comprises a functional selection and speed controlling circuit, a square-wave oscillation and regulating circuit, and a motor driving circuit electrically connected in series manner.

The motion head is capable of being detachably inserted or attached to the rotary shaft, wherein the motion head provides a predetermined function at its head portion. A shape of a connection end of the motion head is flat, square, or cylindrical.

The motion head is connected to the rotary shaft of the motor via a connection shaft, wherein two opposed ends of the connecting shaft has an elongated rectangular shape with one hole formed thereat, wherein one end of the connection shaft is fixedly mounted on the rotary shaft of the motor, and the other end is detachably inserted into the connection end of motion head.

The rotary shaft of the motor further comprises a sealing ring, which is made by waterproof material.

The mounting bracket of the motor has a rectangular shaped adapted for supporting the motor and the power source, such as the battery, of the motor thereat.

A button is further provided on a peripheral surface of the casing and aligned with a switch of the control circuit board, so that when the button is pressed, the switch of the circuit board is controllably activated, to operatively control a working status of the motor.

The casing and a bottom cover are coupled with each other to form the hollow receiving cavity within the casing, wherein the receiving cavity receives the mounting bracket, the motor, the control circuit board, and at least one battery as the power source.

A waterproof sealing rim is provided between the connection of the casing and the bottom cover.

Comparing the present invention to the current techniques, the present invention has the following advantages.

The present invention is easy to use, simple in structure, small in volume, and low in noise and energy consumption. The motion head is directly driven by the motor and the connection shaft. The speed switching and other corresponding functions can be adjusted by controlling the control circuit board without changing other mechanical parts. Detaching and changing the motion head is simple and easy. Accordingly, the motion heads with various formations or practical functions can be selected to detachably insert into or couple with the rotary shaft of the motor or the connection shaft thereof, the electric reciprocating motion device of the present invention can drive the motion head to provide a corresponding formation or practical function thereof.

These and other objectives, features, and advantages of the present invention will become apparent from the following detailed description, the accompanying drawings, and the appended claims.

### BRIEF DESCRIPTION OF THE DRAWINGS

The following description with the accompany drawings give more details description of the present invention.

FIG. 1 is a perspective view of an electric reciprocating motion device applied for an electric toothbrush according to a preferred embodiment of the present invention.

FIG. 2 is an exploded view of the electric reciprocating motion device according to the preferred embodiment of the present invention, wherein the casing and the bottom cover are omitted.

FIG. 3 is a top view of the electric reciprocating motion device according to the preferred embodiment of the present invention.

FIG. 4 is a sectional view of the casing and the bottom cover of the electric reciprocating motion device according to the preferred embodiment of the present invention.

FIG. 5 is a block diagram of the control circuit board of the electric reciprocating motion device according to the preferred embodiment of the present invention.

### DETAILED DESCRIPTION OF THE PREFERRED EMBODIMENT

An electric reciprocating motion device of the present invention applied on an electric toothbrush is described as followings.

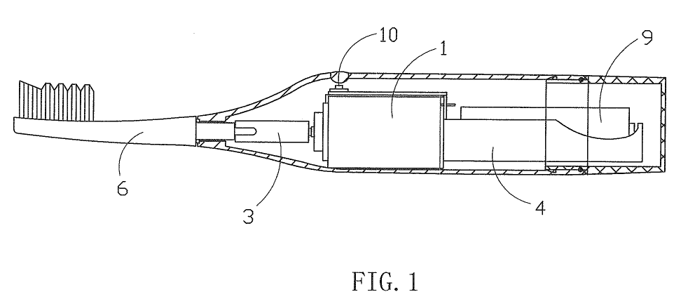

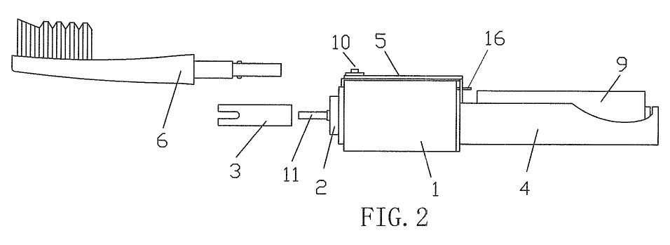

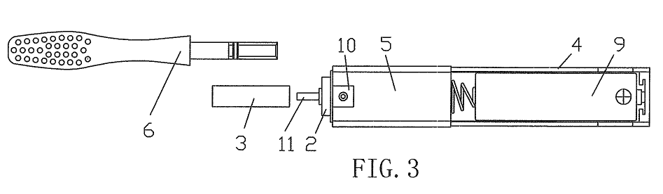

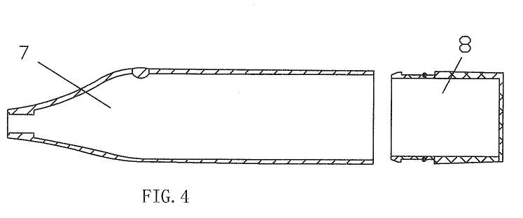

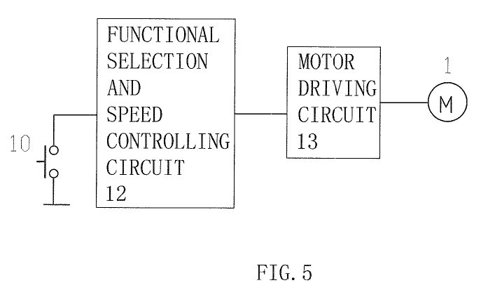

Referring to FIGS. 1 to 5 of the drawings, the electric reciprocating motion device, applied to an electric vertical-type reciprocating motion toothbrush, of the present invention is illustrated. The electric toothbrush comprises a motion head 6 as a brush head, a casing 7 and a bottom cover 8 detachably coupling thereto to form a hollow handle, a mounting bracket 4 integrally received in the hollow handle, wherein the electric reciprocating motion device is supported by the mounting bracket 4. The electric reciprocating motion device comprises a reciprocating swing motor 1, and a battery of a power source 9, and a motor control circuit board 5. The motor 1 comprises a rotary shaft 11 as an output shaft and a waterproof sealing ring 2 mounted at the motor 1 to encircle around the rotary shaft 11, wherein the motion head 6 is coupled with the rotary shaft 11 via a connection shaft 3. The electric reciprocating motion device further comprises a control switch 10 provided at an outer peripheral surface of the casing 7, and a waterproof sealing rim 12 formed a connection between the casing 7 and the bottom cover 8. The motor control circuit board 5 comprises a functional selection and speed controlling circuit 13, a square-wave oscillation and regulating circuit 14, and a motor driving circuit 15 electrically connected in series manner to operatively control the motor 1 in a working status. When the control switch 10 is activated, the functional selection and speed controlling circuit 13, the square-wave oscillation and regulating circuit 14, and the motor driving circuit 15 generate an outputting signal to operate the motor 1 in a working status so as to control the reciprocating speed and other corresponding functions of the rotary shaft 11 of the motor 1. Therefore, when the motion head 6 is coupled at the rotary shaft 11 of the motor 1, the motion head 6 is driven for providing a reciprocating motion thereat along an axis of the rotary shaft 11 in a predetermined angle range regarding to the rotary shaft 11, so as to drive a brush hair on the motion head 6 of the toothbrush to provide the vertically reciprocating motion to brush the teeth up and down. Thus, the up and down vertically reciprocating motion can meet the requirement of oral brushing science that dentists suggested.

The reciprocating swing motor 1 is disclosed from a prior China patent “Reciprocating swing pulse brushless motor” with the Patent number CN2498787Y which is the same applicant as the present invention. The reciprocating swing pulse brushless motor comprises a stator, a rotor, a coil unit, and a spring, wherein the stator comprises two arc-shaped permanent magnets provided at an inner side of the housing of the motor and having two different poles respectively. The magnetic poles are pointed at the center of the motor. The rotor is made of soft magnetic material and is formed as a cylindrical shaped rotor having a plurality of grooves indently formed at the outer peripheral surface of the rotor. A rotation shaft is provided at the center of the rotor, wherein four magnetic poles are encircled around an outer peripheral surface of the core. A plurality of indent grooves with the same interval distance are evenly provided at the rotor between two neighboring magnetic poles, wherein a winding wire of the rotor is wound around the indented groove of the core. The coil unit comprises a plurality of insulated wires winding at the grooves and coupled with each head-to-tail in a directional manner, wherein the insulated wire has two wire ends extended outwardly in responsive to the number of coiled wire. The spring has one end fixed on a spring seat which is located at a tail end of the rotor. An opposed end of the spring is fixed on the bottom of the casing or the bottom cover. The power source 9 can be a 1.5V DC power. The function selection and speed controlling circuit 13 can adapt a dual D trigger 74HC74 chip. The square-wave oscillation and regulating circuit 14 can adapt Schmitt trigger 74HC14 chip.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. An electric reciprocating motion device, comprising a motor, a detachable or affixing motion head, a connection shaft, a casing, a mounting bracket received in said casing, a circuit board, and a power source electrically extended from said motor, wherein said motor, which is a reciprocating swing motor, comprises a rotary shaft adapted for coupling with said motion head through said connection shaft, wherein said motor is activated for providing a reciprocating motion along an axis of said rotary shaft in a predetermined swing angle range.

12. The electric reciprocating motion device, as recited in claim 11, wherein said motion head has a predetermined function at its head portion, wherein a connection end of said motion head has a flat shape, a square shape, or a cylindrical shape.

13. The electric reciprocating motion device, as recited in claim 11, wherein said motion head is coupled with said rotary shaft of said motor via said connection shaft, wherein two opposed ends of said connecting shaft has an elongated rectangular shape with two holes formed thereat respectively, wherein one end of said connection shaft is coupled with said rotary shaft of said motor while another end of said connection shaft is detachably inserted into said motion head.

14. The electric reciprocating motion device, as recited in claim 12, wherein said motion head is coupled with said rotary shaft of said motor via said connection shaft, wherein two opposed ends of said connecting shaft has an elongated rectangular shape with two holes formed thereat respectively, wherein one end of said connection shaft is coupled with said rotary shaft of said motor while another end of said connection shaft is detachably inserted into said motion head.

15. The electric reciprocating motion device, as recited in claim 13, wherein said circuit board comprises a functional selection and speed controlling circuit and a motor driving circuit electrically connected in a series manner to control said motor.

16. The electric reciprocating motion device, as recited in claim 14, wherein said circuit board comprises a functional selection and speed controlling circuit and a motor driving circuit electrically connected in a series manner to control said motor.

17. The electric reciprocating motion device, as recited in claim 15, further comprising a waterproof sealing ring sealed and provided at said rotary shaft of said motor.

18. The electric reciprocating motion device, as recited in claim 16, further comprising a waterproof sealing ring sealed and provided at said rotary shaft of said motor.

19. The electric reciprocating motion device, as recited in claim 17, wherein said mounting bracket is a rectangular frame.

20. The electric reciprocating motion device, as recited in claim 18, wherein said mounting bracket is a rectangular frame.

21. The electric reciprocating motion device, as recited in claim 19, wherein said casing comprises an upper casing and a bottom casing mounted thereto to form a hollow structure.

22. The electric reciprocating motion device, as recited in claim 20, wherein said casing comprises an upper casing and a bottom casing mounted thereto to form a hollow structure.

23. The electric reciprocating motion device, as recited in claim 21, further comprising a button provided at an outer peripheral surface of said casing and aligned with a switch of said circuit board for operatively controlling said circuit board.

24. The electric reciprocating motion device, as recited in claim 22, further comprising a button provided at an outer peripheral surface of said casing and aligned with a switch of said circuit board for operatively controlling said circuit board.

25. The electric reciprocating motion device, as recited in claim 23, wherein said power source is a disposable battery, a rechargeable battery, or a DC regulating power source.

26. The electric reciprocating motion device, as recited in claim 24, wherein said power source is a disposable battery, a rechargeable battery, or a DC regulating power source.
